(19) United States
(12) Patent Application Publication
(10) Pub. No.: US 2025/0022177 A1
(43) Pub. Date: Jan. 16, 2025

(54) METHOD FOR ENCODING/DECODING VIDEO AND RECORDING MEDIUM STORING THE METHOD FOR ENCODING VIDEO

(71) Applicant: Electronics and Telecommunications Research Institute, Daejeon (KR)

(72) Inventors: Gwang Soon LEE, Daejeon (KR); Jun Young JEONG, Daejeon (KR); Dawid MIELOCH, Poznan (PL); Marek DOMANSKI, Poznan (PL); Adrian DZIEMBOWSKI, Poznan (PL)

(73) Assignee: Electronics and Telecommunications Research Institute, Daejeon (KR)

(21) Appl. No.: 18/769,697

(22) Filed: Jul. 11, 2024

(30) Foreign Application Priority Data
Jul. 11, 2023 (KR) 10-2023-0089650
Jul. 10, 2024 (KR) 10-2024-0091337

(51) Int. Cl. G06T 9/00; G06T 5/77; G06V 10/764

(52) U.S. Cl. CPC G06T 9/00; G06T 5/77; G06V 10/764

(57) ABSTRACT

An image encoding method according to the present disclosure may include classifying viewpoint images into a basic image and an additional image; performing pruning on an additional image based on the classification result, generating an atlas by packing patches obtained as a result of performing the pruning; and encoding the atlas and metadata for the atlas. In this case, a margin may be set for a patch within the atlas.

### FIELD OF THE INVENTION

The present disclosure relates to a method of encoding/decoding immersive video that supports motion parallax for rotational and translational movement.

### DESCRIPTION OF THE RELATED ART

Virtual reality services have been evolving to provide services that maximize immersion and realism by generating omnidirectional video in live action or CG (Computer Graphics) form and playing the video on HMDs, smartphones, etc. Currently, it has been known that, in order to play natural and immersive omnidirectional video through an HMD, 6 degrees of freedom (DoF) need to be supported. With regard to 6DoF video, free video needed to be provided through an HMD screen in six directions for (1) left and right rotation, (2) up and down rotation, (3) left and right movement, (4) up and down movement, etc. However, currently, most omnidirectional video standards based on live action merely support rotational motion. Accordingly, research has been actively underway in areas such as technology for acquisition and reproduction of 6DoF omnidirectional video.

### DISCLOSURE

### Technical Problem

The present disclosure is to provide a method for performing viewpoint labeling based on a processing unit smaller than an image when encoding/decoding an image.

The present disclosure is to provide a method for setting a margin where encoding/decoding is omitted for a patch.

The present disclosure is to provide a method for encoding/decoding metadata regarding a margin in a patch.

The technical objects to be achieved by the present disclosure are not limited to the above-described technical objects, and other technical objects which are not described herein will be clearly understood by those skilled in the pertinent art from the following description.

### Technical Solution

An image encoding method according to the present disclosure may include classifying viewpoint images into a basic image and an additional image; performing pruning on an additional image based on the classification result; generating an atlas by packing patches obtained as a result of performing the pruning; and encoding the atlas and metadata for the atlas. In this case, a margin where encoding is omitted may be set for a patch in the atlas.

An image decoding method according to the present disclosure may include decoding an atlas and metadata for the atlas; and rendering a viewport image based on patches in the atlas. In this case, a margin that is not used for rendering the viewport image may be set for a patch in the atlas.

In an image encoding/decoding method according to the present disclosure, the margin may include only pruned pixels.

In an image encoding/decoding method according to the present disclosure, the metadata may include information showing whether it is allowed to set a margin for a patch.

In an image encoding/decoding method according to the present disclosure, the information may be encoded/decoded at a high level, and the high level may include at least one of a video parameter set or a sequence parameter set.

In an image encoding/decoding method according to the present disclosure, the metadata may include size information of the margin.

In an image encoding/decoding method according to the present disclosure, the size information may be encoded/decoded in a unit of a patch.

In an image encoding/decoding method according to the present disclosure, the size information may include at least one of horizontal size information and vertical margin size information.

In an image encoding/decoding method according to the present disclosure, when a value of the horizontal size is N and a value of the vertical size is M, the margin may be a region including N columns from a left boundary, N columns from a right boundary, M rows from a top boundary and M rows from a bottom boundary within the patch.

In an image encoding/decoding method according to the present disclosure, the maximum value of the size information may be determined based on an arrangement unit of a patch within the atlas.

Meanwhile, according to the present disclosure, a computer readable recording medium recording the image encoding method may be provided.

The technical objects to be achieved by the present disclosure are not limited to the above-described technical objects, and other technical objects which are not described herein will be clearly understood by those skilled in the pertinent art from the following description.

### Advantageous Effects

According to the present disclosure, labeling may be performed based on a processing unit smaller than an image, improving encoding/decoding efficiency of an image.

According to the present disclosure, a margin where encoding/decoding is omitted may be set for a patch, improving encoding/decoding efficiency of an image.

According to the present disclosure, a method for encoding/decoding metadata regarding a margin in a patch may be provided, improving encoding/decoding efficiency of an image and enhancing rendering quality.

Effects achievable by the present disclosure are not limited to the above-described effects, and other effects which are not described herein may be clearly understood by those skilled in the pertinent art from the following description.

### BRIEF DESCRIPTION OF THE DRAWINGS

FIG. 1 is a block diagram of an immersive video processing device according to an embodiment of the present disclosure.

FIG. 2 is a block diagram of an immersive video output device according to an embodiment of the present disclosure.

FIG. 3 is a flow chart of an immersive video processing method.

FIG. 4 is a flow chart of an atlas encoding process.

FIG. 5 is a flow chart of an immersive video output method.

FIGS. 6 and 7 are a diagram for describing an atlas packing aspect of viewpoint images.

FIGS. 8 and 9 show an atlas generation aspect according to a unit of performing viewpoint labeling.

FIGS. 10A and 10B are examples of a patch generation method according to the present disclosure.

FIGS. 11A and 11B compare atlases with a different arrangement of valid data in a patch.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

An immersive video, when a user's viewing position is changed, refers to a video that a viewport image may be also dynamically changed. In order to implement an immersive video, a plurality of input images are required. Each of a plurality of input images may be referred to as a source image or a view image. A different view index may be assigned to each view image. An immersive image may be composed of images each of which has different view, thus, the immersive video can also be referred to as multi-view image.

An immersive video may be classified into 3DoF (Degree of Freedom), 3DoF+, Windowed-6DoF or 6DoF type, etc. A 3DoF-based immersive video may be implemented by using only a texture image. On the other hand, in order to render an immersive video including depth information such as 3DoF+ or 6DoF, etc., a depth image (or, a depth map) as well as a texture image is also required.

It is assumed that embodiments described below are for immersive video processing including depth information such as 3DoF+ and/or 6DoF, etc. In addition, it is assumed that a view image is configured with a texture image and a depth image.

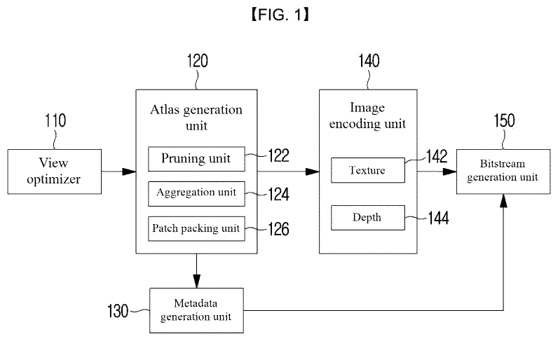

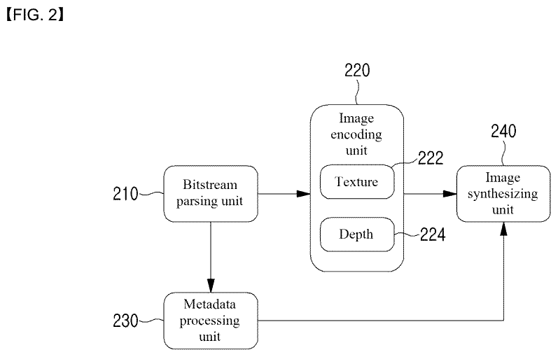

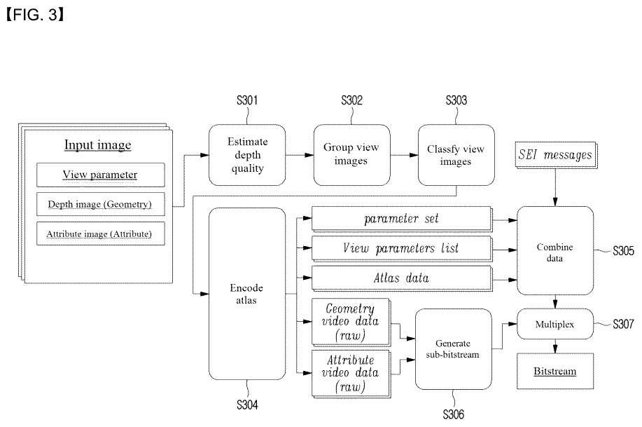

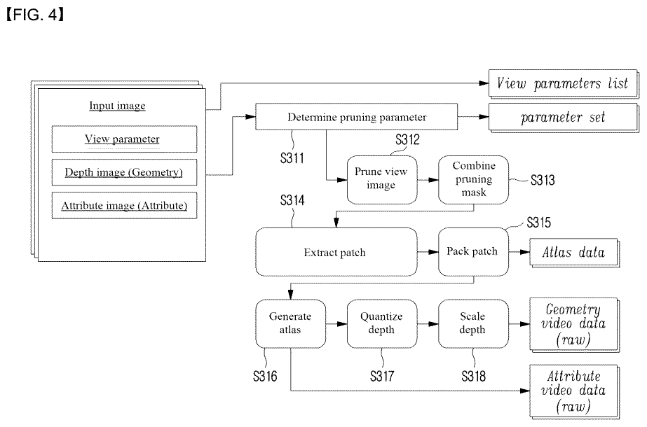

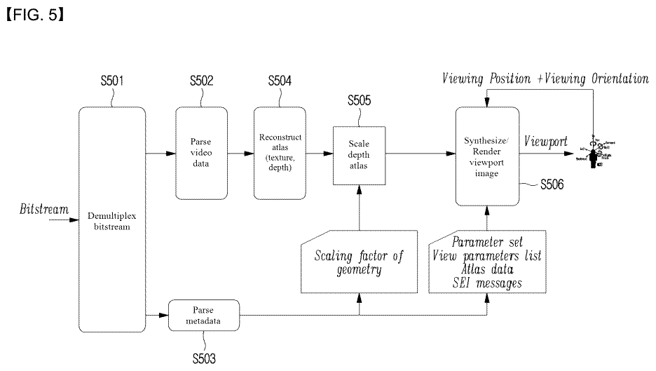

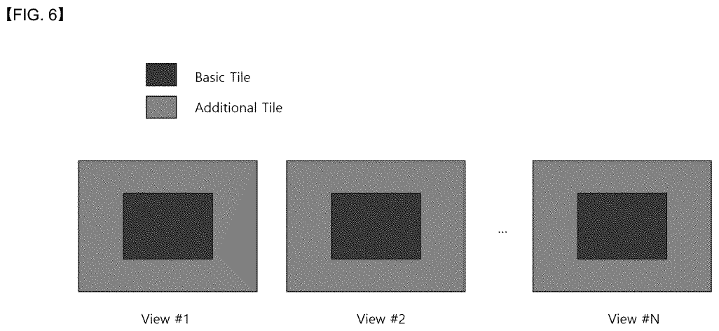

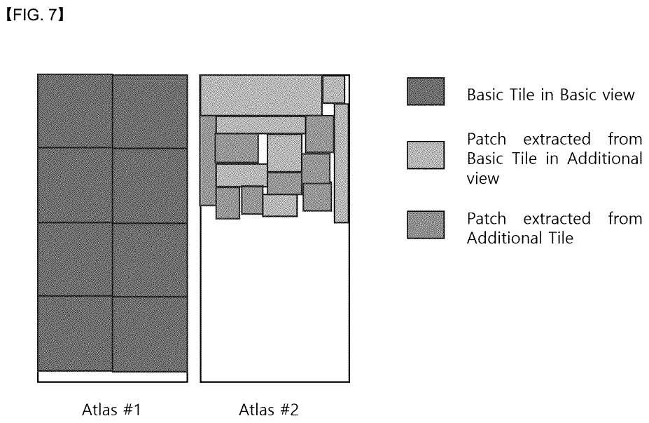

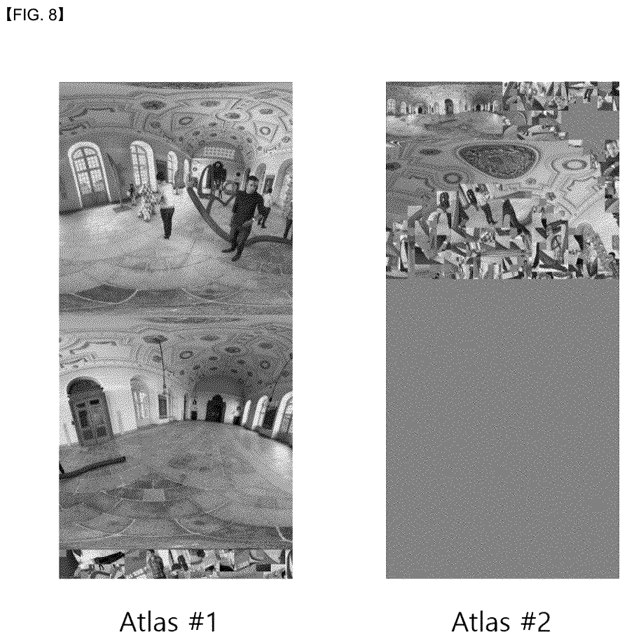

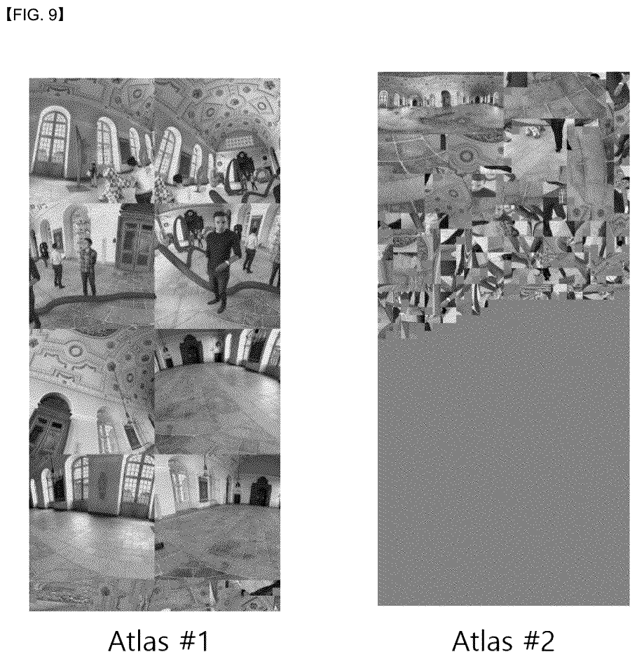

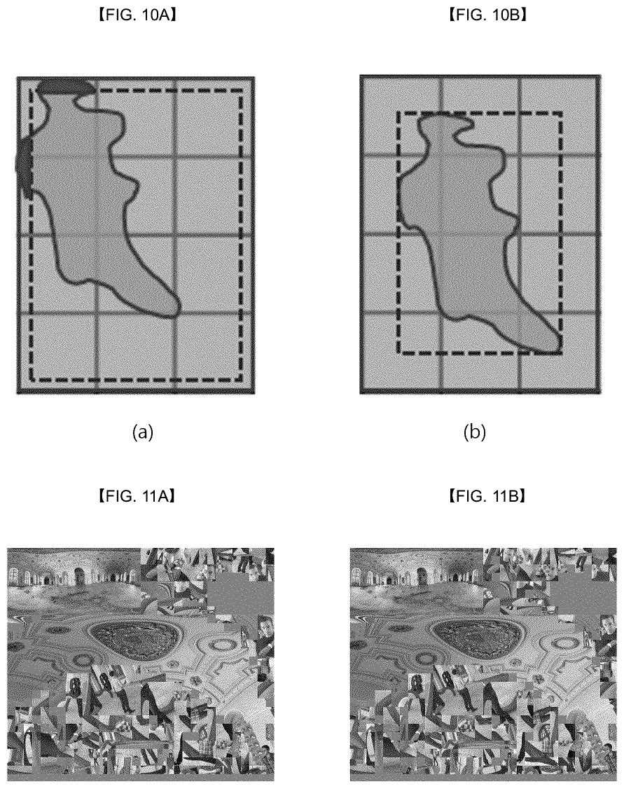

FIG. 1 is a block diagram of an immersive video processing device according to an embodiment of the present disclosure.

In reference to FIG. 1, an immersive video processing device according to the present disclosure may include a view optimizer 110, an atlas generation unit 120, a metadata generation unit 130, an image encoding unit 140 and a bitstream generation unit 150.

An immersive video processing device receives a plurality of pairs of images, a camera intrinsic parameters and a camera extrinsic parameter as an input data to encode an immersive video. Here, a plurality of pairs of images include a texture image (Attribute component) and a depth image (Geometry component). Each pair may have a different view. Accordingly, a pair of input images may be referred to as a view image. Each of view images may be divided by an index. In this case, an index assigned to each view image may be referred to as a view or a view index.

A camera intrinsic parameters includes a focal distance, a position of a principal point, etc. and a camera extrinsic parameters includes translations, rotations, etc. of a camera. A camera intrinsic parameters and a camera extrinsic parameters may be treated as a camera parameter or a view parameter.

A view optimizer 110 partitions view images into a plurality of groups. As view images are partitioned into a plurality of groups, independent encoding processing per each group may be performed. In an example, view images captured by N spatially consecutive cameras may be classified into one group. Thereby, view images that depth information is relatively coherent may be put in one group and accordingly, rendering quality may be improved.

In addition, by removing dependence of information between groups, a spatial random access service which performs rendering by selectively bringing only information in a region that a user is watching may be made available.

Whether view images will be partitioned into a plurality of groups may be optional.

In addition, a view optimizer 110 may perform view labeling for view images. View labeling is for classifying view images into a basic image and an additional image. A basic image represents an image which is not pruned as a view image with a highest pruning priority and an additional image represents a view image with a pruning priority lower than a basic image.

A view optimizer 110 may determine at least one of view images as a basic image. A view image which is not selected as a basic image may be classified as an additional image.

A view optimizer 110 may determine a basic image by considering a view position of a view image. In an example, a view image whose view position is the center among a plurality of view images may be selected as a basic image.

Alternatively, a view optimizer 110 may select a basic image based on camera parameters. Specifically, a view optimizer 110 may select a basic image based on at least one of a camera index, a priority between cameras, a position of a camera or whether it is a camera in a region of interest.

In an example, at least one of a view image with a smallest camera index, a view image with a largest camera index, a view image with the same camera index as a predefined value, a view image captured by a camera with a highest priority, a view image captured by a camera with a lowest priority, a view image captured by a camera at a predefined position (e.g., a central position) or a view image captured by a camera in a region of interest may be determined as a basic image.

Alternatively, a view optimizer 110 may determine a basic image based on quality of view images. In an example, a view image with highest quality among view images may be determined as a basic image.

Alternatively, a view optimizer 110 may determine a basic image by considering an overlapping data rate of other view images after inspecting a degree of data redundancy between view images. In an example, a view image with a highest overlapping data rate with other view images or a view image with a lowest overlapping data rate with other view images may be determined as a basic image.

Alternatively, a view optimizer 110 may determine farthest view image as a basic image.

A plurality of view images may be also configured as a basic image.

An Atlas generation unit 120 performs pruning and generates a pruning mask. And, it extracts a patch by using a pruning mask and generates an atlas by combining a basic image and/or an extracted patch. When view images are partitioned into a plurality of groups, the process may be performed independently per each group.

A generated atlas may be composed of a texture atlas and a depth atlas. A texture atlas represents a basic texture image and/or an image that texture patches are combined and a depth atlas represents a basic depth image and/or an image that depth patches are combined.

An atlas generation unit 120 may include a pruning unit 122, an aggregation unit 124 and a patch packing unit 126.

A pruning unit 122 performs pruning for an additional image based on a pruning priority. Specifically, pruning for an additional image may be performed by using a reference image with a higher pruning priority than an additional image.

A reference image includes a basic image. In addition, according to a pruning priority of an additional image, a reference image may further include other additional image.

Whether an additional image may be used as a reference image may be selectively determined. In an example, when an additional image is configured not to be used as a reference image, only a basic image may be configured as a reference image.

On the other hand, when an additional image is configured to be used as a reference image, a basic image and other additional image with a higher pruning priority than an additional image may be configured as a reference image.

Through a pruning process, redundant data between an additional image and a reference image may be removed. Specifically, through a warping process based on a depth image, data overlapped with a reference image may be removed in an additional image. In an example, when a depth value between an additional image and a reference image is compared and that difference is equal to or less than a threshold value, it may be determined that a corresponding pixel is redundant data.

As a result of pruning, a pruning mask including information on whether each pixel in an additional image is valid or invalid may be generated. A pruning mask may be a binary image which represents whether each pixel in an additional image is valid or invalid. In an example, in a pruning mask, a pixel determined as overlapping data with a reference image may have a value of 0 and a pixel determined as non-overlapping data with a reference image may have a value of 1.

While a non-overlapping region may have a non-square shape, a patch is limited to a square shape. Accordingly, a patch may include an invalid region as well as a valid region. Here, a valid region refers to a region composed of non-overlapping pixels between an additional image and a reference image. In other words, a valid region represents a region that includes data which is included in an additional image, but is not included in a reference image. An invalid region refers to a region composed of overlapping pixels between an additional image and a reference image. That is, an invalid region may be composed of pruned pixels. A pixel/data included by a valid region may be referred to as a valid pixel/valid data and a pixel/data included by an invalid region may be referred to as an invalid pixel/invalid data.

An aggregation unit 124 combines a pruning mask generated in a frame unit in an intra-period unit.

In addition, an aggregation unit 124 may extract a patch from a combined pruning mask image through a clustering process. Specifically, a square region including valid data in a combined pruning mask image may be extracted as a patch. Regardless of a shape of a valid region, a patch is extracted in a square shape, so a patch extracted from a square valid region may include invalid data as well as valid data.

In this case, an aggregation unit 124 may repartition a L-shaped or C-shaped patch which reduces encoding efficiency. Here, a L-shaped patch represents that distribution of a valid region is L-shaped and a C-shaped patch represents that distribution of a valid region is C-shaped.

When distribution of a valid region is L-shaped or C-shaped, a region occupied by an invalid region in a patch is relatively large. Accordingly, a L-shaped or C-shaped patch may be partitioned into a plurality of patches to improve encoding efficiency.

For an unpruned view image, a whole view image may be treated as one patch. Specifically, a whole 2D image which develops an unpruned view image in a predetermined projection format may be treated as one patch. A projection format may include at least one of an Equirectangular Projection Format (ERP), a Cube-map or a Perspective Projection Format.

Here, an unpruned view image refers to a basic image with a highest pruning priority. Alternatively, an additional image that there is no overlapping data with a reference image and a basic image may be defined as an unpruned view image. Alternatively, regardless of whether there is overlapping data with a reference image, an additional image arbitrarily excluded from a pruning target may be also defined as an unpruned view image. In other words, even an additional image that there is data overlapping with a reference image may be defined as an unpruned view image.

A packing unit 126 packs a patch in a rectangle image. In patch packing, deformation such as size transform, rotation, or flip, etc. of a patch may be accompanied. An image that patches are packed may be defined as an atlas.

Specifically, a packing unit 126 may generate a texture atlas by packing a basic texture image and/or texture patches and may generate a depth atlas by packing a basic depth image and/or depth patches.

For a basic image, a whole basic image may be treated as one patch. In other words, a basic image may be packed in an atlas as it is. When a whole image is treated as one patch, a corresponding patch may be referred to as a complete image (complete view) or a complete patch.

The number of atlases generated by an atlas generation unit 120 may be determined based on at least one of an arrangement structure of a camera rig, accuracy of a depth map or the number of view images.

A metadata generation unit 130 generates metadata for image synthesis. Metadata may include at least one of camera-related data, pruning-related data, atlas-related data or patch-related data.

Pruning-related data includes information for determining a pruning priority between view images. In an example, at least one of a flag representing whether a view image is a root node or a flag representing whether a view image is a leaf node may be encoded. A root node represents a view image with a highest pruning priority (i.e., a basic image) and a leaf node represents a view image with a lowest pruning priority.

When a view image is not a root node, a parent node index may be additionally encoded. A parent node index may represent an image index of a view image, a parent node.

Alternatively, when a view image is not a leaf node, a child node index may be additionally encoded. A child node index may represent an image index of a view image, a child node.

Atlas-related data may include at least one of size information of an atlas, number information of an atlas, priority information between atlases or a flag representing whether an atlas includes a complete image. A size of an atlas may include at least one of size information of a texture atlas and size information of a depth atlas. In this case, a flag representing whether a size of a depth atlas is the same as that of a texture atlas may be additionally encoded. When a size of a depth atlas is different from that of a texture atlas, reduction ratio information of a depth atlas (e.g., scaling-related information) may be additionally encoded. Atlas-related information may be included in a “View parameters list” item in a bitstream.

In an example, geometry_scale_enabled_flag, a syntax representing whether it is allowed to reduce a depth atlas, may be encoded/decoded. When a value of a syntax geometry_scale_enabled_flag is 0, it represents that it is not allowed to reduce a depth atlas. In this case, a depth atlas has the same size as a texture atlas.

When a value of a syntax geometry_scale_enabled_flag is 1, it represents that it is allowed to reduce a depth atlas. In this case, information for determining a reduction ratio of a depth atlas may be additionally encoded/decoded. In an example, geometry_scaling_factor_x, a syntax representing a horizontal directional reduction ratio of a depth atlas, and geometry_scaling_factor_y, a syntax representing a vertical directional reduction ratio of a depth atlas, may be additionally encoded/decoded.

An immersive video output device may restore a reduced depth atlas to its original size after decoding information on a reduction ratio of a depth atlas.

Patch-related data includes information for specifying a position and/or a size of a patch in an atlas image, a view image to which a patch belongs and a position and/or a size of a patch in a view image. In an example, at least one of position information representing a position of a patch in an atlas image or size information representing a size of a patch in an atlas image may be encoded. In addition, a source index for identifying a view image from which a patch is derived may be encoded. A source index represents an index of a view image, an original source of a patch. In addition, position information representing a position corresponding to a patch in a view image or position information representing a size corresponding to a patch in a view image may be encoded. Patch-related information may be included in an “Atlas data” item in a bitstream.

An image encoding unit 140 encodes an atlas. When view images are classified into a plurality of groups, an atlas may be generated per group. Accordingly, image encoding may be performed independently per group.

An image encoding unit 140 may include a texture image encoding unit 142 encoding a texture atlas and a depth image encoding unit 144 encoding a depth atlas.

A bitstream generation unit 150 generates a bitstream based on encoded image data and metadata. A generated bitstream may be transmitted to an immersive video output device.

FIG. 2 is a block diagram of an immersive video output device according to an embodiment of the present disclosure.

In reference to FIG. 2, an immersive video output device according to the present disclosure may include a bitstream parsing unit 210, an image decoding unit 220, a metadata processing unit 230 and an image synthesizing unit 240.

A bitstream parsing unit 210 parses image data and metadata from a bitstream. Image data may include data of an encoded atlas. When a spatial random access service is supported, only a partial bitstream including a watching position of a user may be received.

An image decoding unit 220 decodes parsed image data. An image decoding unit 220 may include a texture image decoding unit 222 for decoding a texture atlas and a depth image decoding unit 224 for decoding a depth atlas.

A metadata processing unit 230 unformats parsed metadata.

Unformatted metadata may be used to synthesize a specific view image. In an example, when motion information of a user is input to an immersive video output device, a metadata processing unit 230 may determine an atlas necessary for image synthesis and patches necessary for image synthesis and/or a position/a size of the patches in an atlas and others to reproduce a viewport image according to a user's motion.

An image synthesizing unit 240 may dynamically synthesize a viewport image according to a user's motion. Specifically, an image synthesizing unit 240 may extract patches required to synthesize a viewport image from an atlas by using information determined in a metadata processing unit 230 according to a user's motion. Specifically, a viewport image may be generated by extracting patches extracted from an atlas including information of a view image required to synthesize a viewport image and the view image in the atlas and synthesizing extracted patches.

FIGS. 3 and 5 show a flow chart of an immersive video processing method and an immersive video output method, respectively.

In the following flow charts, what is italicized or underlined represents input or output data for performing each step. In addition, in the following flow charts, an arrow represents processing order of each step. In this case, steps without an arrow indicate that temporal order between corresponding steps is not determined or that corresponding steps may be processed in parallel. In addition, it is also possible to process or output an immersive video in order different from that shown in the following flow charts.

An immersive video processing device may receive at least one of a plurality of input images, a camera internal variable and a camera external variable and evaluate depth map quality through input data S301. Here, an input image may be configured with a pair of a texture image (Attribute component) and a depth image (Geometry component).

An immersive video processing device may classify input images into a plurality of groups based on positional proximity of a plurality of cameras S302. By classifying input images into a plurality of groups, pruning and encoding may be performed independently between adjacent cameras whose depth value is relatively coherent. In addition, through the process, a spatial random access service that rendering is performed by using only information of a region a user is watching may be enabled.

But, the above-described S301 and S302 are just an optional procedure and this process is not necessarily performed.

When input images are classified into a plurality of groups, procedures which will be described below may be performed independently per group.

An immersive video processing device may determine a pruning priority of view images S303. Specifically, view images may be classified into a basic image and an additional image and a pruning priority between additional images may be configured.

Subsequently, based on a pruning priority, an atlas may be generated and a generated atlas may be encoded S304. A process of encoding atlases is shown in detail in FIG. 4.

Specifically, a pruning parameter (e.g., a pruning priority, etc.) may be determined S311 and based on a determined pruning parameter, pruning may be performed for view images S312. As a result of pruning, a basic image with a highest priority is maintained as it is originally. On the other hand, through pruning for an additional image, overlapping data between an additional image and a reference image is removed. Through a warping process based on a depth image, overlapping data between an additional image and a reference image may be removed.

As a result of pruning, a pruning mask may be generated. If a pruning mask is generated, a pruning mask is combined in a unit of an intra-period S313. And, a patch may be extracted from a texture image and a depth image by using a combined pruning mask S314. Specifically, a combined pruning mask may be masked to texture images and depth images to extract a patch.

In this case, for an non-pruned view image (e.g., a basic image), a whole view image may be treated as one patch.

Subsequently, extracted patches may be packed S315 and an atlas may be generated S316. Specifically, a texture atlas and a depth atlas may be generated.

In addition, an immersive video processing device may determine a threshold value for determining whether a pixel is valid or invalid based on a depth atlas S317. In an example, a pixel that a value in an atlas is smaller than a threshold value may correspond to an invalid pixel and a pixel that a value is equal to or greater than a threshold value may correspond to a valid pixel. A threshold value may be determined in a unit of an image or may be determined in a unit of a patch.

For reducing the amount of data, a size of a depth atlas may be reduced by a specific ratio S318. When a size of a depth atlas is reduced, information on a reduction ratio of a depth atlas (e.g., a scaling factor) may be encoded. In an immersive video output device, a reduced depth atlas may be restored to its original size through a scaling factor and a size of a texture atlas.

Metadata generated in an atlas encoding process (e.g., a parameter set, a view parameter list or atlas data, etc.) and SEI (Supplemental Enhancement Information) are combined S305. In addition, a sub bitstream may be generated by encoding a texture atlas and a depth atlas respectively S306. And, a single bitstream may be generated by multiplexing encoded metadata and an encoded atlas S307.

An immersive video output device demultiplexes a bitstream received from an immersive video processing device S501. As a result, video data, i.e., atlas data and metadata may be extracted respectively S502 and S503.

An immersive video output device may restore an atlas based on parsed video data S504. In this case, when a depth atlas is reduced at a specific ratio, a depth atlas may be scaled to its original size by acquiring related information from metadata S505.

When a user's motion occurs, based on metadata, an atlas required to synthesize a viewport image according to a user's motion may be determined and patches included in the atlas may be extracted. A viewport image may be generated and rendered S506. In this case, in order to synthesize viewpoint image with the patches, size/position information of each patch and a camera parameter, etc. may be used.

Meanwhile, in the above-described embodiments, it was described that classification is performed into a ‘base’ image or an ‘additional’ image in a unit of an image. Unlike a described example, classification in a ‘basic’ processing unit and an ‘additional’ processing unit may also be performed based on a sub-processing unit within an image. Here, a sub-processing unit may include at least one of a sub-picture, a tile or a slice.

A ‘basic’ processing unit may be packed into an atlas without being pruned. On the other hand, pruning may be performed on an ‘additional’ processing unit. After pruning is performed on an additional processing unit, patches extracted from the residual data in an additional processing unit may be packed into an atlas. In other words, the residual data in an additional processing unit may be divided into square patches, and patches may be packed into an atlas in a form like a mosaic.

In other words, a basic processing unit represents an image processing unit that is processed with a basic image, and an additional processing unit represents an image processing unit that is processed with an additional image. As an example, when a lower processing unit is a ‘tile’, a basic processing unit may represent a basic tile, and an additional processing unit may represent an additional tile.

One picture may be divided into a plurality of tiles. In this case, a division form of a tile may be determined in a unit of a sequence or in a unit of a picture. As an example, when the division information of a tile is encoded and signaled in a unit of a sequence, a tile division form of pictures referring to the sequence may be the same.

When a picture is divided into a plurality of tiles, each tile may be classified as a basic tile or an additional tile. While pruning is not performed on a basic tile, pruning may be performed on an additional tile.

Meanwhile, classification into a basic tile or an additional tile may be performed only for a viewpoint image determined as a basic image among the viewpoint images. While pruning is not performed on a basic tile in a basic image, pruning may be performed on an additional tile in a basic image.

On the other hand, all tiles within a viewpoint image determined as an additional image may be treated as an additional tile.

As another example, before performing labeling in a ‘basic’ processing unit and an ‘additional’ processing unit, labeling in a ‘basic’ processing unit and an ‘additional’ processing unit may be performed for a lower processing unit within a picture in a unit of an image.

As an example, each of the input viewpoint images may be divided into two regions such as a basic tile and an additional tile. Here, a basic tile may be a region including at least one of a region of a predetermined size including a center position within a picture, a region including a main object within a picture or a region of interest within a picture. Here, a main object may be at least one of an object closest to a camera, an object positioned at a center position within a picture or an object included in a region of interest among the objects included in a picture.

An additional tile may represent the remaining regions excluding a basic tile within a picture.

Thereafter, viewpoint labeling may be performed only for a basic tile for each of the viewpoint images. In other words, based on a basic tile, whether a corresponding viewpoint image is a basic image or an additional image may be determined. Meanwhile, viewpoint labeling may be performed through a viewpoint optimization unit 110 described above.

If a viewpoint image is determined as a basic image, pruning may not be performed on a basic tile within a basic image. In other words, a basic tile within a basic image may be packed into an atlas as it is.

On the other hand, when a viewpoint image is determined as an additional image, pruning may be performed on a basic tile within an additional image. In other words, for a basic tile within an additional image, patches may be extracted from the residual data obtained by performing pruning, and extracted patches may be packed into an atlas.

Meanwhile, regardless of a viewpoint labeling result, pruning may be performed on an additional tile, and extracted patches may be packed into an atlas according to a pruning result. In other words, for an additional tile included in a basic image, redundant data may be removed through pruning, just like an additional tile included in an additional image.

As a result, there is an advantage in that the encoding/decoding efficiency of an atlas image may be improved by limiting a region where pruning is not performed in a basic image to a basic tile and removing redundant data from the remaining regions excluding a basic tile within a basic image.

FIGS. 6 and 7 are a diagram for describing an atlas packing aspect of viewpoint images.

FIG. 6 shows an example in which each viewpoint image is classified as a basic tile and an additional tile. In FIG. 6, it is assumed that for each viewpoint image, a region of a predetermined size including a center position is designated as a basic tile and a region excluding a basic tile is designated as an additional tile.

Viewpoint labeling may be performed based on basic tiles. As a result of performing viewpoint labeling, each viewpoint image may be classified as a basic image or an additional image.

For a basic tile in a viewpoint image classified as a basic image, pruning may not be performed. Accordingly, as in an example shown in FIG. 7, a basic tile in a basic image may be packed into an atlas as it is (atlas #1 in FIG. 7).

For a basic tile in an additional image, pruning may be performed. Accordingly, as in an example shown in FIG. 7, patches extracted from a basic tile may be packed into an atlas (atlas #2 in FIG. 7).

Meanwhile, regardless of a viewpoint labeling result, pruning may be performed on an additional tile. Accordingly, as in an example shown in FIG. 7, patches extracted from an additional tile may be packed into an atlas (atlas #2 in FIG. 7).

FIGS. 8 and 9 show an atlas generation aspect according to a unit of performing viewpoint labeling.

FIG. 8 shows a result of performing viewpoint labeling in a unit of a viewpoint image. In this case, as in an example shown in FIG. 8, a basic image may be packed into an atlas as it is.

FIG. 9 shows a result of performing viewpoint labeling in a unit of a tile. In this case, as in an example shown in FIG. 9, only a basic tile in a basic image may be packed into an atlas as it is. In other words, an additional tile in a basic image may be packed into an atlas through pruning.

Meanwhile, performing viewpoint labeling in a unit of a tile according to the present disclosure may be applied not only to a full 360-degree image, but also to a non-full 360-degree image.

Alternatively, a unit of performing viewpoint labeling may be adaptively determined according to an image type. As an example, when an input image is a first type image, viewpoint labeling may be performed in a unit of a viewpoint image. On the other hand, when an input image is a second type image, viewpoint labeling may be performed in a unit of a tile.

Meanwhile, as described above, residual data generated through pruning may be clustered, and a rectangular region including valid data in a clustered image may be extracted as a patch. In this case, a patch may be generated in a form where valid data touches a boundary of a patch. As an example, a position of a leftmost sample of valid data may be set as a left boundary of a patch, and a position of an uppermost sample of valid data may be set as a top boundary of a patch.

As another example, valid data may be positioned in the middle of a patch to improve encoding/decoding efficiency. Specifically, valid data may be positioned in the middle of a patch, and a margin (or a marginal region) may be set between valid data and a boundary of a patch.

According to the present disclosure, a margin may be set to improve encoding/decoding efficiency or rendering quality.

As an example, encoding/decoding may be omitted for a patch margin. Here, when encoding/decoding of a patch margin is omitted, it may mean that a patch margin is excluded from an encoding/decoding target or that a patch margin is encoded/decoded in a skip mode.

Alternatively, when a patch margin is set as an encoding/decoding target, for a patch margin, an immersive image processing device may fill a patch margin by using an inpainting technique. In addition, an immersive image output device may be set not to use data included in a patch margin when rendering (or synthesizing) a viewport image, improving encoding/decoding efficiency and rendering quality.

FIG. 10 is an example of a patch generation method according to the present disclosure.

FIG. 10 (a) shows an example in which valid data is arranged according to a left and top boundary of a patch, and FIG. 10 (b) shows an example in which valid data is arranged at the center of a patch.

In FIGS. 10 (a) and (b), a dotted line shows a boundary between a marginal region and a non-marginal region within a patch. A patch margin may be the remaining regions excluding a predetermined rectangular region including a center position within a patch. Accordingly, a patch margin may be defined as an offset indicating a distance from a boundary of a patch to a rectangular region.

Data belonging to a marginal region within a patch may not be used in image rendering (or synthesis). Accordingly, as in an example shown in FIG. 10 (a), when valid data is arranged according to a left boundary and a top boundary of a patch, part of valid data belongs to a marginal region in a rendering process. Accordingly, when valid data is arranged according to a left boundary and a top boundary of a patch, part of valid data may be lost. In addition, when valid data is arranged according to a left boundary and a top boundary of a patch, there is a problem that a marginal region may not be set sufficiently large.

On the other hand, as shown in FIG. 10 (b), if valid data is arranged at the center of a patch, even if a marginal region is set large, valid data will not be lost.

In other words, instead of arranging valid data based on a boundary of a patch, by arranging valid data at the center of a patch, a marginal region proposed in the present disclosure may be set sufficiently large.

By arranging valid data at the center of a patch, valid data may be set not to be included in a patch margin. In other words, only invalid data (i.e., pruned pixels) may be included in a patch margin, and a patch margin may not be used for rendering.

As described above, a marginal region is not used for viewport rendering.

Accordingly, an immersive image processing device may modify the data of a marginal region within a patch to ensure that an error in decoding/encoding valid data is reduced.

As an example, a patch boundary corresponding to a patch margin is indicated as a hole, and a region indicated as a hole may be colored through a repetitive inpainting technique.

As an example, in a first iteration, a 3×3 window may be used to fill an empty pixel with a non-empty pixel within a 3×3 window. In this case, if there are a plurality of non-empty pixels, the average of a plurality of pixels may be filled in an empty pixel.

In a second iteration, a size of a window may be increased to 5×5 to fill an empty pixel in the same method.

As an iteration is repeated, a width and a height of a window may be expanded by 2, respectively.

Inpainting may continue until a hole does not exist in a patch or until a size of a window reaches a preset size.

As an example, if a size of a window reaches 63×63, a 63×63-sized window may be used to fill an empty pixel and terminate inpainting.

Meanwhile, for planarization within an inpainted region, inpainted pixels within a local region may be replaced with the average value of inpainted pixels.

Through the method, a cloudy state may be maintained for a hole region, while maintaining an edge close to a cluster.

FIG. 11 compares atlases with a different arrangement of valid data in a patch.

FIG. 11 (a) shows an example in which valid data is arranged at the center of a patch, and FIG. 11 (b) shows an example in which valid data is arranged to adjoin a left boundary and a top boundary of a patch.

If FIG. 11 (a) is compared with FIG. 11 (b), it may be confirmed that the position of patches in an atlas is the same, but data within a patch is different. Specifically, it may be confirmed that data within a patch shown in FIG. 11 (a) is in a form that data within a patch shown in FIG. 11 (b) is slightly moved in a bottom-right corner direction.

Meanwhile, as valid data is moved in a bottom-right direction, it may be confirmed that some 64×64-sized regions in an unoccupied state in FIG. 11 (b) are changed into an occupied state in FIG. 11 (a).

Meanwhile, information about a margin within a patch may be encoded as metadata and signaled.

As an example, at a high level, information showing whether it is allowed to set a margin within a patch may be encoded and signaled. A high level may include at least one of a Video Parameter Set (VPS), a Sequence Parameter Set or a Picture Header.

Table 1 shows an example in which information showing whether it is allowed to set a margin within a patch may be encoded and signaled through a video parameter set.

TABLE 1

| | Descriptor |
|---|---|
| vps_miv_2_extension( ) { | |
| vps_miv_extension( ) | |
| vme_reserved_zero_8bits | u(8) |
| vme_decoder_side_depth_estimation_flag | u(1) |
| vme_patch_margin_enabled_flag | u(1) |
| } | |

In Table 1, a syntax vme_patch_margin_enabled_flag shows whether it is allowed to set a margin within a patch. As an example, when a value of a syntax vme_patch_margin_enabled_flag is 1, information related to a patch margin parameter may further exist in a bitstream.

On the other hand, when a syntax vme_patch_margin_enabled_flag is 0, information related to a patch margin parameter may not exist in a bitstream. In other words, when a value of a syntax vme_patch_margin_enabled_flag is 0, a margin may not exist within a patch.

Meanwhile, when vme_patch_margin_enabled_flag does not exist in a bitstream, its value may be inferred as 0.

Information about a patch margin may be encoded and signaled per patch. As an example, when a syntax vme_patch_margin_enabled_flag is 1, information about a size of a margin may be encoded and signaled per patch.

Table 2 shows an example in which information about a margin is encoded and signaled per patch. In Table 2, tileID shows an identifier of a tile to which a patch belongs among the tiles within an atlas. In addition, p shows an index allocated to a patch.

TABLE 2

| | Descriptor |
|---|---|
| pdu_miv_extension( tileID, p ) { | |
| if( asme_max_entity_id > 0 ) | |
| pdu_entity_id[ tileID ][ p ] | u(v) |
| if( asme_depth_occ_threshold_flag ) | |
| pdu_depth_occ_threshold[ tileID ][ p ] | u(v) |
| if( asme_patch_texture_offset_enabled_flag ) | |
| for( c = 0; c < 3; c++ ) | |
| pdu_texture_offset[ tileID ][ p ][ c ] | u(v) |
| if( asme_inpaint_enabled_flag ) | |
| pdu_inpaint_flag[ tileID ][ p ] | u(1) |
| if( vme_patch_margin_enabled_flag ) | |
| pdu_3d_margin_u[ tileID ][ p ] | u(v) |
| pdu_3d_margin_v[ tileID ][ p ] | u(v) |
| } | |

A margin size for a horizontal direction and a margin size for a vertical direction may be independently determined. Accordingly, information showing a patch margin size for a vertical direction and information showing a patch margin size for a vertical direction may be independently encoded and signaled.

As an example, in Table 2, a syntax pdu_3d_margin_u [tileID] [p] shows a size of a horizontal margin of a patch where an index is p. As an example, when a value of a syntax pdu_3d_margin_u is N, it represents that N leftmost sample columns of a patch and N rightmost sample columns in a patch are set as a patch margin. Meanwhile, a size of a margin must be smaller than a size of a patch. Accordingly, a value of a syntax pdu_3d_margin_u may belong to a range from 0 to (patch_width/2) or a range from 0 to ((patch_width/2)−1). Here, patch_width represents a width of a patch.

In Table 2, a syntax pdu_3d_margin_v [tileID] [p] shows a size of a vertical margin of a patch where an index is p. As an example, when a value of a syntax pdu_3d_margin_v is N, it represents that N uppermost sample rows of a patch and N lowermost sample rows in a patch are set as a patch margin. Meanwhile, a size of a margin must be smaller than a size of a patch. Accordingly, a value of a syntax pdu_3d_margin_v may belong to a range from 0 to (patch_height/2) or a range from 0 to ((patch_height/2)−1). Here, patch_height represents a height of a patch.

Alternatively, based on an arrangement unit of a patch, the maximum value of a syntax pdu_3d_margin_u and a syntax pdu_3d_margin_v may be determined, respectively.

Specifically, the maximum number of bits (i.e., the maximum value) for expressing a syntax pdu_3d_margin_u and a syntax pdu_3d_margin_v may be determined based on information signaled from a bitstream. As an example, the maximum number of bits allocated to each of a syntax pdu_3d_margin_u and a syntax pdu_3d_margin_v may be (asps_log 2_patch_packing_block_size−1).

Here, asps_log 2_patch packing_block_size represents a unit for determining a horizontal and vertical arrangement of a patch in an atlas with information signaled from sps. As an example, a variable PatchPackingBlockSize may be derived as in Equation 1 below.

$$PatchPackingBlockSize = {2}^{asps \_ log 2 \_ patch \_ packing \_ block \_ size} \qquad [ Equation l ]$$

A position of a patch in an atlas may be determined based on the variable PatchPackingBlockSize. As an example, each of a x-coordinate and a y-coordinate of a top-left sample in a patch within an atlas may be expressed as a multiple of the variable PatchPackingBlockSize.

As a result, the maximum number of bits (i.e., the maximum value) of a syntax pdu_3d_margin_u and a syntax pdu_3d_margin_v may be ½ of a variable PatchPackingBlockSize, respectively.

Meanwhile, a horizontal margin size and a vertical margin size may be set to be mutually the same. In this case, encoding/decoding for any one of a syntax pdu_3d_margin_u and a syntax pdu_3d_margin_v may be omitted.

Information showing whether a margin is set per patch may be encoded and signaled. As an example, a 1-bit flag showing whether a margin is set for a current patch may be encoded and signaled. Only when the flag indicates that a margin is set for a current patch, information showing a size of a patch margin may be additionally encoded/decoded.

Alternatively, encoding/decoding of information showing a size of a patch margin may be omitted, and a size of a patch margin may be set as a default value. Here, a default value may be predefined in an encoder and a decoder.

Alternatively, a default value may be adaptively determined according to a size of a patch. In this case, a size of a horizontal margin (i.e., a horizontal default value) may be determined based on a width of a patch, and a size of a vertical margin (i.e., a vertical default value) may be determined based on a height of a patch.

Instead of encoding and signaling patch margin size-related information for each patch, patch margin size-related information may be encoded and signaled at a level higher than a patch. As an example, patch margin size-related information may be encoded and signaled in a unit of a tile in an atlas or in a unit of an atlas. As an example, a margin size of patches belonging to a current tile may be set to be the same according to a margin size encoded/decoded for a current tile in an atlas.

Alternatively, patch margin size-related information is encoded and signaled at a level higher than a patch, but information showing whether a margin size is set may be encoded and signaled by referring to information signaled at a high level for each patch. As an example, a flag showing whether a patch margin is set may be encoded and signaled for each patch by referring to information signaled at a high level.

If it indicates that a flag for a current patch refers to a high level, encoding/decoding of patch margin size information for a current patch may be omitted, and a margin size of a current patch may be determined according to patch margin size information encoded/decoded at a high level.

On the other hand, if it indicates that a flag for a current patch does not refer to a high level, patch margin size information (e.g., a syntax pdu_3d_margin_u and a syntax pdu_3d_margin_v) may be encoded/decoded for a current patch, and a margin size of a current patch may be determined based on patch margin size information encoded/decoded for a current patch.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A method of encoding an image, the method comprising:
classifying viewpoint images into a basic image and an additional image;
based on the classification result, performing a pruning on the additional image;
generating an atlas by packing patches obtained as a result of performing the pruning; and
encoding the atlas and metadata for the atlas,
wherein a margin is set for a patch within the atlas.

2. The method of claim 1, wherein:
the margin includes only pruned pixels.

3. The method of claim 1, wherein:
the metadata includes information showing whether it is allowed to set the margin for a patch.

4. The method of claim 3, wherein:
the information is encoded at a high level, and
the high level includes at least one of a video parameter set or a sequence parameter set.

5. The method of claim 1, wherein:
the metadata includes size information of the margin.

6. The method of claim 5, wherein:
the size information is encoded in a unit of a patch.

7. The method of claim 5, wherein:
the size information includes at least one of horizontal size information and vertical margin size information.

8. The method of claim 7, wherein:
when a value of the horizontal size is N, and a value of the vertical size is M, and
the margin is a region including N columns from a left boundary, N columns from a right boundary, M rows from a top boundary and M rows from a bottom boundary within the patch.

9. The method of claim 5, wherein:
a maximum value of the size information is determined based on an arrangement unit of the patch in the atlas.

10. The method of claim 1, wherein:
a pixel within the margin is generated through an inpainting.

11. An image decoding method, the method comprising:
decoding an atlas and metadata for the atlas; and
based on patches within the atlas, rendering a viewport image,
wherein a margin that is not used for rendering the viewport image is set for a patch within the atlas.

12. The method of claim 11, wherein:
the margin includes only pruned pixels.

13. The method of claim 11, wherein:
the metadata includes information showing whether it is allowed to set a margin for the patch.

14. The method of claim 13, wherein:
the information is signaled through a high level,
the high level includes at least one of a video parameter set or a sequence parameter set.

15. The method of claim 11, wherein:
the metadata includes size information of the margin.

16. The method of claim 15, wherein:
the size information is decoded in a unit of a patch.

17. The method of claim 15, wherein:
the size information includes at least one of horizontal size information and vertical margin size information.

18. The method of claim 17, wherein:
when a value of the horizontal size is N, and a value of the vertical size is M, and
the margin is a region including N columns from a left boundary, N columns from a right boundary, M rows from a top boundary and M rows from a bottom boundary within the patch.

19. The method of claim 15, wherein:
a maximum value of the size information is determined based on an arrangement unit of the patch within the atlas.

20. A computer readable recording medium recording an instruction for performing an image encoding method, the computer readable recording medium comprising:
classifying viewpoint images into a basic image and an additional image;
based on the classification result, performing a pruning on the additional image;
generating an atlas by packing patches obtained as a result of performing the pruning; and
encoding the atlas and metadata for the atlas,
wherein a margin is set for a patch within the atlas.
